(19) United States
(12) Patent Application Publication
(10) Pub. No.: US 2013/0283204 A1
(43) Pub. Date: Oct. 24, 2013

(54) Systems and Methods for Displaying Information or a Feature in Overscroll Regions on Electronic Devices

(71) Applicants: Jerome Pasquero, Kitchener (CA); Noel John Orland Stonehouse, Waterloo (CA); Eric Philip Loney, Waterloo (CA)

(72) Inventors: Jerome Pasquero, Kitchener (CA); Noel John Orland Stonehouse, Waterloo (CA); Eric Philip Loney, Waterloo (CA)

(73) Assignee: RESEARCH IN MOTION LIMITED, Waterloo, ON (CA)

(21) Appl. No.: 13/634,687

(22) PCT Filed: Apr. 18, 2012
(86) PCT No.: PCT/CA2012/050246

§ 371 Date: Sep. 13, 2012

(51) Int. Cl. G06F 3/0484

(52) U.S. Cl. CPC G06F 3/0484
USPC 715/784

(57) ABSTRACT

A method and system are provided for displaying on an electronic device by displaying an overscroll region on a display of the electronic device, and displaying information associated with the electronic device or features associated with at least one application of the electronic device, in the overscroll region. The method may include obtaining an overscroll region at the display, and determining information associated with the overscroll region, and selecting the at least one of information or a feature associated with the electronic device or at least one application of the electronic device.

### TECHNICAL FIELD

The following relates generally to displaying one or more regions on electronic devices, in response to an overscrolling input.

### BACKGROUND

Many electronic devices, including mobile devices, display only a portion of the content (e.g. document, webpage, list or other forms of data) of interest to a user at a given time on a display of the electronic device. In order to view a different portion of the content, the user can provide an input to the electronic device to display a different portion of the content.

### BRIEF DESCRIPTION OF THE DRAWINGS

Example embodiments will now be described by way of example only with reference to the appended drawings wherein:

FIG. 1 is a diagram of an example display of a mobile device, displaying a portion of the content of interest to a user.

FIGS. 2a-2b are diagrams of the display of portions of the content, which were previously undisplayed in the example of FIG. 1.

FIGS. 3a-3b are diagrams of example gestures to signal to the mobile device to display a portion of the content, which was previously undisplayed in the example of FIG. 1.

FIG. 4a is a diagram of an example display of a mobile device, displaying a portion of the content of interest to a user.

FIGS. 4b-4c are diagrams of example gestures to signal to the mobile device to display portions of the content, which were previously undisplayed in the example of FIG. 4a.

FIG. 5 is a diagram of an example wireless communication system.

FIGS. 6-7 are plan views of example mobile devices and a display screens therefor.

FIG. 8 is a block diagram of an example embodiment mobile device.

FIG. 9 is an example screen shot of a main screen displayed by a mobile device.

FIG. 10 is a block diagram of example software applications and components, previously shown in FIG. 8.

FIG. 11 is a block diagram of an example overscroll region display application.

FIG. 12 is a flow diagram of an example set of processor or computer executable instructions for displaying an overscroll region on a mobile device.

FIGS. 13-16 are diagrams of examples transformations of content displayed on a mobile device.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practised without these specific details. In other instances, well-known methods, procedures and components have not been described in detail so as not to obscure the example embodiments described herein. Also, the description is not to be considered as limiting the scope of the example embodiments described herein.

Many electronic devices, including mobile devices, provide a user input in the form of a scrolling input in a particular direction to translate the content displayed on the device in the same direction. For example, the scrolling input in an electronic device having a touch-screen display can include placing an object, such as a finger of the user, on the touch-screen display and moving the object in a direction to cause the device to scroll the content in the same direction. In one example, the device can scroll the content as long as the scrolling input is applied. In another example, scrolling can continue after the scrolling input has ended based on properties of the scrolling input (e.g. proportional to the scrolling input's rate of acceleration prior to ending, and inversely proportional to the time interval after the scrolling input has ended, to provide a dampened scrolling motion).

Given the use of scrolling, electronic devices may provide a visual indicator to the user to indicate that a boundary of the content has been reached. One such visual indicator is to allow the device to scroll beyond a boundary of the content to display an “overscroll” region. The overscroll region can be displayed when a scrolling input results in scrolling the content in a direction beyond one of its boundaries. In one example, the overscroll region can remain displayed as long as the scrolling input is applied. Once the scrolling input has been removed, the content can scroll back in the reverse direction such that the overscroll region is no longer displayed. This may give the effect of having the content being displayed “snap” back to the boundary. In another example, a scrolling input can be of such magnitude that after a scrolling input has ended, the content continues to scroll past one of its boundaries. Once the scrolling has ended, the content can scroll back in the reverse direction such that the overscroll region is no longer displayed.

As discussed above, many electronic devices, including mobile devices, display an overscroll region to provide a visual indicator to a user to indicate that a boundary of the content has been reached. The overscroll region can be blank or dead-space of a solid colour, have the same background as the content displayed, or be a wallpaper image such as a picture or pattern. The overscroll region does not convey much information (if any) beyond that the boundary of the content has been reached.

With the popularity of mobile devices including touch-screen displays and user interfaces that incorporate overscroll regions, users are often attracted to the overscroll region and deliberately apply scrolling inputs to invoke the display of the overscroll region.

It has been recognized that methods for displaying overscroll regions on an electronic device such as a mobile device are typically limited in the information conveyed to the user in the overscroll region. To address this, the following describes a method, computer readable storage medium and mobile device operable to display overscroll regions. The method includes displaying an overscroll region on a display of the mobile device, and displaying at least one of information associated with the mobile device or a feature associated with an application of the mobile device, in the overscroll region. The method may include determining information associated with the overscroll region, and selecting information associated with the mobile device or features associated with applications of the mobile device, to display based on the information associated with the overscroll region. A portion of the overscroll region may be selectable.

In some example embodiments, the information associated with the mobile device or features of an application of the mobile device, can include at least one of an image, an icon, and text.

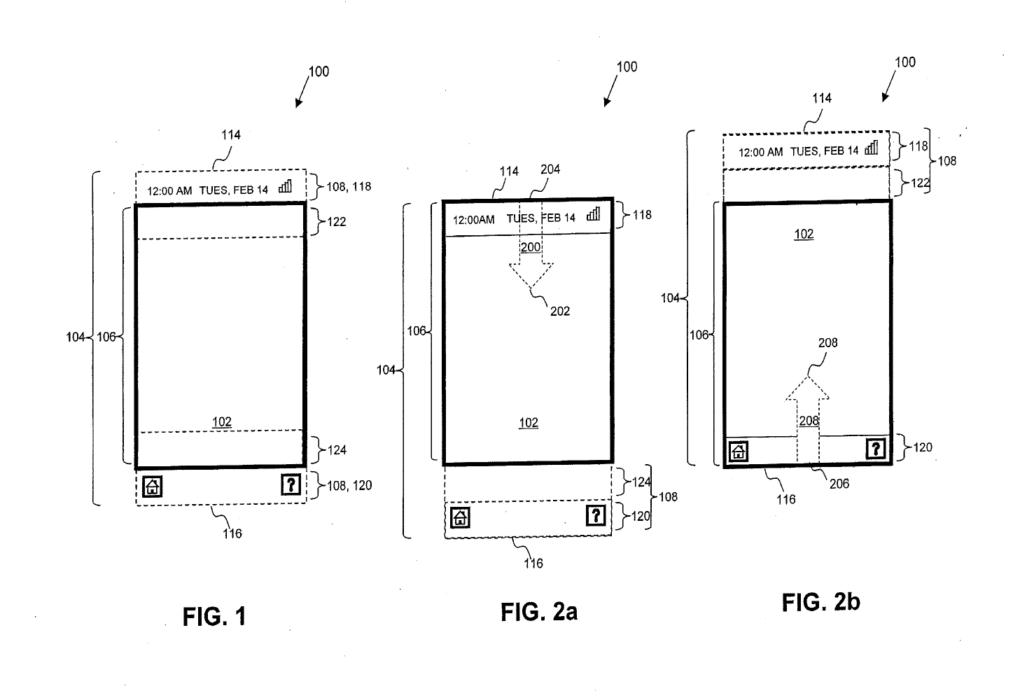

Referring to FIGS. 1-4c, diagrams of an example touch-screen display 102 of a mobile device 100 displaying content 104 are provided. The content 104 includes a displayed portion 106 and undisplayed portions 108. In the examples of FIGS. 1-4c, the content 104 has an upper boundary 114, and a lower boundary 116.

As shown in FIG. 1, the display 102 can display a displayed portion 106 (including regions 122 and 124) of content 104. In this example, undisplayed portions 108 are above and below the displayed portion 106. In an example embodiment displayed portion 106 may include a display of at least one active or open application of mobile device 100, such as for example a main screen application (showing icons of other applications on mobile device 100) or a messaging application, a phone application, a media player application, or a web browsing application,

In FIG. 2a, a scrolling input 200 that has been applied to scroll the content 104 can be received by mobile device 100 in the direction of the scrolling input 200 (downward). After receiving scrolling input 200, mobile device 100 displays overscroll region 118 (which was previously undisplayed, as shown in FIG. 1), in the displayed portion 106. In the example of FIG. 2, the upper boundary 114 of content 104 is aligned with the upper boundary of the display 102. The overscroll region 118 in this example includes information or features associated with mobile device 100 or an application of the mobile device: current time, current date, wireless signal strength. Other information or features may be included in overscroll region 118, such as for example wireless carrier information, Wi-Fi service, battery strength, an unread email, an unheard voicemail. The information or features associated with mobile device 100 or an application of the mobile device may be displayed in a text format or an icon (or other symbol) format.

In the example embodiment shown in FIG. 2a, the scrolling input 200 is a downward gesture made by a finger of a user of mobile device 100, that is received through display 102 which is a touch-screen display. In the example gesture, the user places his finger on display 102 at or about point 204 (at or near the top edge of display 102) and drags his finger on the display downward to about point 202. (In another example gesture, the user places his finger above the display 102 (e.g. above point 204), and drags his finger onto the display and downward to about point 202. In this example gesture, a touch-sensitive frame such as 704 of FIG. 7, can detect the user placing his finger above point 204.) The downward movement of this example gesture is similar to the movement used to pull down a spring-loaded window shade. (When a user wishes to pull down a spring-loaded window shade, the user grabs the bottom of the window shade and pulls downward until the window shade is at a desired vertical length.)

After the downward gesture is made, overscroll region 118 is displayed or revealed at display 102. (In another example, while the downward gesture is being made, at least part of overscroll region 118 is revealed at display 102.) The example embodiment of FIG. 2a shows that when overscroll region 118 is revealed, region 124 (which was included in displayed portion 106 in FIG. 1), is no longer displayed in displayed portion 106. This displaying of overscroll region 118 and non-displaying of region 124, after the downward gesture is made, creates an appearance of pushing region 124 off display 102.

After the downward gesture is made, the user may lift his finger from display 102 and the displayed portion 106 of FIG. 2a reverts back to the displayed portion 106 shown in FIG. 1. The lifting movement of this example gesture is similar to the movement used to revert a spring-loaded window shade to its rolled position. (When a user wishes to revert a spring-loaded window shade to its rolled position, the user grabs the bottom of the window shade, tugs at it, and then releases the window shade.) Similar to the movement of a spring-loaded window shade scrolling to its rolled position, when the displayed portion 106 of FIG. 2a reverts back to the displayed portion 106 shown in FIG. 1, in an example embodiment, the displayed portion 106 scrolls upward. In another example embodiment, when reverting back to the displayed portion 106 shown in FIG. 1, displayed portion 106 of FIG. 2a “snaps” back to the displayed portion 106 shown in FIG. 1.

In another example embodiment of FIG. 2a, after the gesture of scrolling input 200 is made, the user may hold the position of his finger at or about point 202, for a predetermined amount of time, to signal to mobile device 100 that the user wishes to maintain the displayed portion 106 (including overscroll region 118) of FIG. 2a. After the predetermined amount of time, the user may lift his finger from display 102 and the displayed portion 106 of FIG. 2a is maintained on display 102. After this hold gesture is made, if a user wishes to revert the displayed portion 106 of FIG. 2a back to the displayed portion 106 shown in FIG. 1, the user may make another gesture, such as for example: tapping on the display or placing his finger on display 102 at or about point 202 and dragging his finger on the display upward to about point 204.

In FIG. 2b, a scrolling input 208 that has been applied to scroll the content 104 can be received by mobile device 100 in the direction of the scrolling input 208 (upward). After receiving scrolling input 208, mobile device 100 displays overscroll region 120 (which was previously undisplayed, as shown in FIG. 1), in displayed portion 106. In the example of FIG. 2b, the lower boundary 116 of content 104 is aligned with the lower boundary of the display 102. The overscroll region 120 in this example includes icons or symbols indicating features about the mobile device or an application of the mobile device: a main screen icon (in which upon selection, can invoke a display of the mobile device's main screen) and a help or information icon (in which upon selection, can invoke the display of information about the mobile device or information about an active application currently displayed in displayed portion 106). Other icons or symbols indicating features about the mobile device or an application of the mobile device may be included in overscroll region 120. For example, when an email application is active, open and displayed in displayed portion 106, overscroll region 120 may include icons related to the email application (such as for example a create a message icon, a forward a message icon, a reply to a message icon, and filing a message icon, in which upon selection respectively, can invoke the features respectively: create a message, reply to a message, forward a message and file a message). In another example, when a media player application is active, open and displayed in displayed portion 106, overscroll region 120 may include icons related to the media player application (such as for example a play media icon, a pausing media icon, a forwarding media icon and a reversing media icon, in which upon selection respectively, can invoke the features respective: play a media file, pause a media file, forward a media file, and reverse a media file).

In the example embodiment of FIG. 2b, the scrolling input 208 is an upward gesture made by a finger of a user of mobile device 100, that is received through display 102 which is a touch-screen display. In the example gesture, the user places his finger on display 102 at or about point 206 (at or near the bottom edge of display 102) and drags his finger on the display upward to about point 208. (In another example gesture, the user places his finger below the display 102 (e.g. below point 206), and drags his finger onto the display and upward to about point 208. In this example gesture, a touch-sensitive frame such as 704 of FIG. 7, can detect the user placing his finger below point 206.)

After the upward gesture is made, overscroll region 120 is displayed or revealed at display 102. (In another example, while the downward gesture is being made, at least part of overscroll region 120 is revealed at display 102.) The example embodiment of FIG. 2b shows that when overscroll region 120 is revealed, region 122 (which was included in displayed portion 106 in FIG. 1), is no longer displayed in displayed portion 106. This displaying of overscroll region 120 and non-displaying of region 122, after the upward gesture is made, creates an appearance of pushing region 122 off display 102.

After the gesture is made, the user may lift his finger from the display 102 and the displayed portion 106 of FIG. 2b reverts back to the displayed portion 106 shown in FIG. 1. When the displayed portion 106 of FIG. 2b reverts back to the displayed portion 106 shown in FIG. 1, in an example embodiment, the displayed portion 106 scrolls downward. In another example embodiment, when the displayed portion 106 of FIG. 2b reverts back to the displayed portion 106 shown in FIG. 1, the displayed portion 106 of FIG. 2b “snaps” back to the displayed portion shown in FIG. 1.

In another example embodiment of FIG. 2b, after the gesture of scrolling input 208 is made, the user may hold the position of his finger at or about point 204, for a predetermined amount of time, to signal to mobile device 100 that the user wishes to maintain the displayed portion 106 (including overscroll region 120) of FIG. 2a. After the predetermined amount of time, the user may lift his finger from display 102 and the displayed portion 106 of FIG. 2a is maintained on display 102. After this hold gesture is made, if a user wishes to revert the displayed portion 106 of FIG. 2b back to the displayed portion 106 shown in FIG. 1, the user may make another gesture, such as for example: tapping on the display or placing his finger on display 102 at or about point 204 and dragging his finger on the display downward to about point 202.

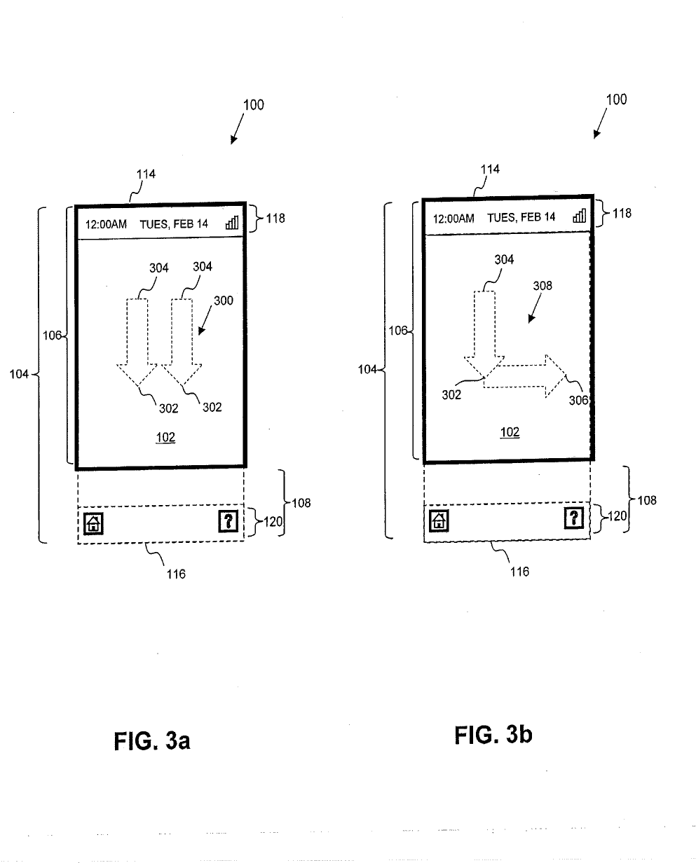

In the example embodiment of FIG. 3a, a scrolling input 300 that has been applied to scroll the content 104 can be received by mobile device 100 in the direction of the scrolling input 300 (downward). After receiving scrolling input 300, mobile device 100 displays overscroll region 118, which was previously undisplayed (as shown in FIG. 1). In this example, the scrolling input 300 is a downward gesture made by two fingers of a user of mobile device 100, that is received through display 102 which is a touch-screen display. In the example gesture, the user places two of his fingers on display 102 at or about points 304 and drags his fingers on the display downward to about points 302. A similar gesture that is upward can be made by two fingers of a user of mobile device 100, to display overscroll region 120.

In the example embodiment of FIG. 3b, a scrolling input 308 that has been applied to scroll the content 104 can be received by mobile device 100 in the direction of the scrolling input 308 (downward). After receiving scrolling input 308, mobile device 100 displays overscroll region 118, which was previously undisplayed (as shown in FIG. 1). In this example, the scrolling input 308 is a downward gesture made by a finger of a user of mobile device 100, that is received through display 102 which is a touch-screen display. In the example gesture, the user places his finger on display 102 at or about point 304, drags his finger on the display downward to about point 302, then (without lifting his finger) drags his finger on the display to the right to about point 306. This gesture, in an example embodiment, signals to mobile device 100 that the user wishes to maintain the displayed portion 106 of FIG. 3b. The ‘L’ movement of this example gesture is similar to the movement used to maintain the position of the window blind that is controlled by a cord. (When a user wishes to maintain the position of a window blind, the user pulls the cord downward until the window blind is at a desired vertical length, and then moves the cord to the right.) In another example embodiment, a similar gesture to maintain a display of overscroll region 120, is an upside down ‘L’ movement gesture (i.e. upward and to the right) made by a finger of a user of mobile device 100.

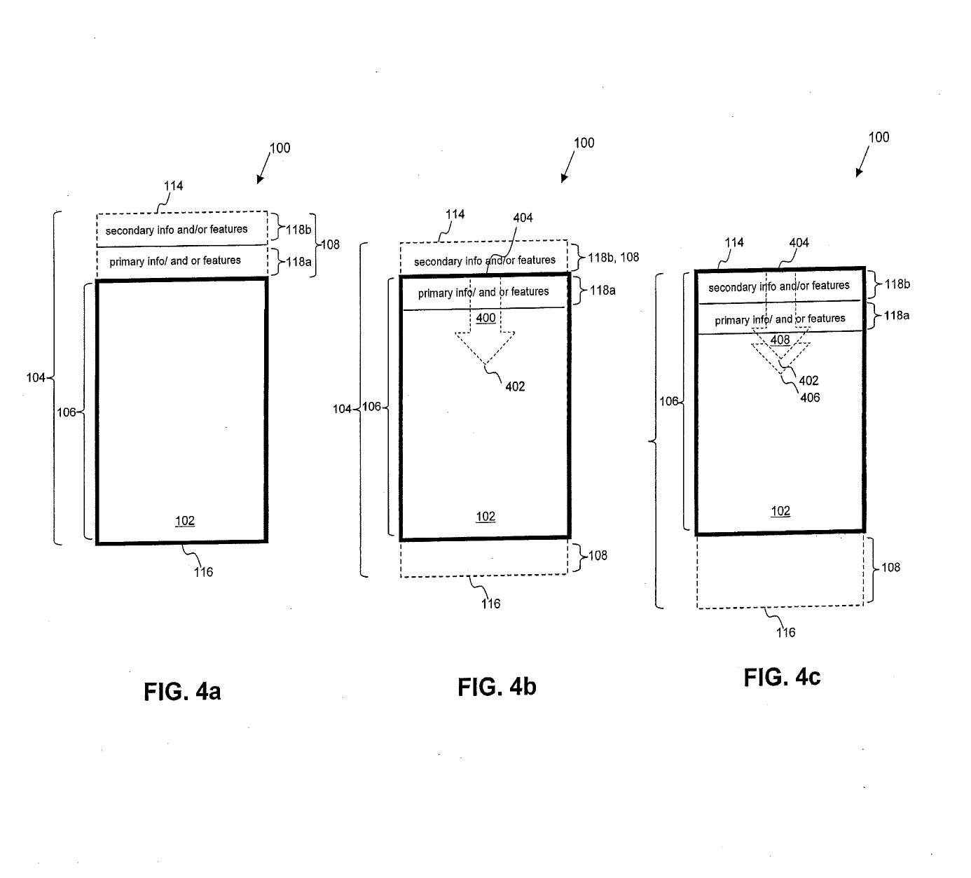

In the example embodiment of FIG. 4a, content 104 includes undisplayed portions 108, in addition to displayed portion 106.

In the example embodiment of FIG. 4b, a scrolling input 400 that has been applied to scroll the content 104 can be received by mobile device 100 in the direction of the scrolling input 400 (downward). After receiving scrolling input 400, mobile device 100 displays overscroll region 118a, which was previously undisplayed (as shown in FIG. 4a). The scrolling input 400 is a downward gesture made by a finger of a user of mobile device 100, that is received through display 102 which is a touch-screen display. In the example gesture, the user places his finger on display 102 at or about point 404 (at or near the top edge of display 102) and drags his finger on the display downward to about point 402. (In another example gesture, the user places his finger above the display 102 (e.g. above point 404), and drags his finger onto the display and downward to about point 402.) After the downward gesture is made, overscroll region 118a is displayed or revealed at display 102. (In another example, while the downward gesture is being made, at least part of overscroll region 118a is revealed at display 102.) The overscroll region 118a in this example includes primary information and/or features associated with: mobile device 100, the active application currently displayed in displayed portion 106, a feature of the active application currently displayed in displayed portion 106, and/or other applications and features of applications currently not displayed in portion 106.

In the example embodiment of FIG. 4c, after scrolling input 400 is made, a user may make a further scrolling input 408, to further scroll the content 104 in the direction of the scrolling input 408 (downward). After receiving scrolling input 408, mobile device 100 further displays overscroll region 118b, which was previously undisplayed (as shown in FIG. 4a). The scrolling input 408 is a downward gesture made by a finger of a user of mobile device 100, that is received through display 102 which is a touch-screen display. In the example gesture, the user has already made the downward gesture as discussed above in relation to FIG. 4b and so the user's finger is already on display 102 at or about point 402; the user then drags his finger on the display further downward to about point 406. After the further downward gesture is made, overscroll region 118b is displayed or revealed at display 102. (In another example, while the further downward gesture is being made, at least part of overscroll region 118b is revealed at display 102.) The overscroll region 118b in this example includes secondary information and/or features associated with: mobile device 100, the active application currently displayed in displayed portion 106, a feature of the active application currently displayed in displayed portion 106, other applications currently not displayed in portion 106, and/or features of other applications currently not displayed in portion 106.

In an example embodiment, the primary information and/or features in overscroll region 118a include features associated with a feature of the active application currently displayed in displayed portion 106. For example, if the active application is a messaging application, and a feature of the messaging application that is currently displayed (in displayed portion 106) is the feature of viewing a single message; the primary information and/or features may then include: a reply icon, a forward icon and a file icon (in which upon selection respectively, can invoke the features respectively: reply to the message, forward the message and file the message), In another example, if the active application is an address book application, and a feature of the address book application that is currently displayed (in displayed portion 106) is the feature of viewing a single contact; the primary information and/or features may then include: an email icon, a phone icon, a text icon, and an instant message icon (in which upon selection respectively, can invoke the features respectively: email the contact, phone the contact, send a text message to the contact, or send an instant message to the contact),

In an example embodiment, the secondary information and/or features in overscroll region 118b include features associated with the mobile device, applications that are not currently displayed in displayed portion 106, and/or features of applications that are not currently displayed in displayed portion 106. For example, if the active application currently displayed (in displayed portion 106) is a messaging application, the secondary information and/or features may include icons associated with applications that are currently not displayed in displayed portion 106 (such as a main screen icon, an address book icon, an unread email icon, an unheard voicemail icon, in which upon selection respectively, can invoke respectively a display and activation of the mobile device's main screen, the address book application, the email application or the voicemail application). In another example, the secondary information and/or features may include a help or information icon (in which upon selection, can invoke the display of information about the mobile device or information about the active messaging application), and/or information associated with mobile device 100 (such as current time, current date, wireless signal strength, and wireless carrier information).

In the example embodiments of FIG. 2a-2b, 3a-3b, 4a-4c, the example gestures are global gestures. In other words, regardless of the application that is active, open and displayed in displayed portion 106, after receiving scrolling inputs 200, 208, 300, 300′, 300″, 308, 400, 408 or other example gestures, the mobile device 100 can accordingly display and maintain the display of overscroll regions 118, 118a-118b, and 120 of content 104.

The gestures illustrated in FIGS. 2a-b2, 3a-3b, 4a-4c are example gestures, in which mobile device 100 may be pre-configured to receive. In other example embodiments, a user may define particular gestures and configure mobile device 100 to receive these particular gestures to accordingly display and maintain the display of overscroll regions 118, 118a-118b, and 120 of content 104.

Furthermore, the gestures illustrated in FIGS. 2a-b2, 3a-3b, 4a-4c are example global gestures, in which mobile device 100 disambiguates from typical scrolling gestures, to display and maintain the display of overscroll regions 118, 118a-118b, and 120 of content 104, as opposed to performing typical scrolling. Accordingly, the global gestures to display and maintain the display of the overscroll region may be pre-configured to be unambiguously different than typical scrolling gestures. As a typical scrolling gesture includes making the gesture with one finger, initially placing the finger anywhere but at the edge of the display, and performing the gesture in one movement (e.g. downward or upward), the global gestures illustrated in 2a-b2, 3a-3b, 4a-4c are different than typical scrolling gestures and thus can signal to mobile device that the user wishes to display and maintain the display of an overscroll region (as opposed to performing typical scrolling). Such a global gesture can be useful in the scenario in which the content 104 is very lengthy and must be scrolled to view the entire content; a user may invoke the global gesture to cause the overscroll region to be displayed, without having to scroll through to the bottom (or the top) of the content,

It will be appreciated that the scrolling input should not be limited a touch-screen display input device, for example, other forms of inputs such as a mouse drag, trackpad scroll, trackball scroll, etc. can cause the overscroll region 118, 118a, 118b, or 120 to be displayed.

It can therefore be seen that overscroll regions 118, 118a, 118b, and 120, which were previously undisplayed, can be used to communicate information about mobile device 100, or about features associated with the mobile device or applications of the mobile device. It can be useful to display information in this manner to minimize the use of space on the display 102 of the mobile device 100 that can be available to display other content, thus also minimizing the intrusiveness of the information and/or features on the user. The example embodiments disclosed herein can provide the user with the ability to control the display of information displayed on mobile device 100, by controlling the scrolling inputs 200, 208, 300, 308, 400 and/or 408.

Examples of applicable mobile devices may include, without limitation, cellular phones, smart-phones, tablet computers, pagers, wireless organizers, personal digital assistants, computers, laptops, handheld wireless communication devices, wirelessly enabled notebook computers, portable gaming devices, and the like. Such devices will hereinafter be commonly referred to as “mobile devices” 100 for the sake of clarity. It will however be appreciated that the principles described herein are also suitable to other electronic devices, e.g. “non-mobile” devices. For example, the principles herein are equally applicable to personal computers (PCs), tabletop computing devices, wall-mounted screens such as kiosks, or any other computing device that includes a display.

In an example embodiment, the mobile device 100 can be a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

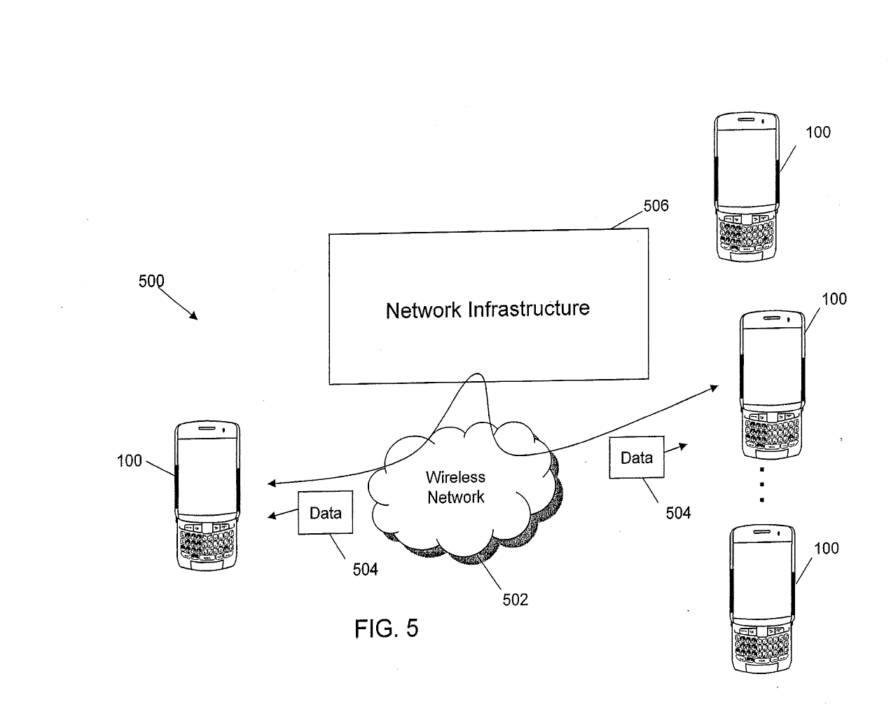

Referring to FIG. 5, an example communication system 500 is shown. The communication system 500, in this example embodiment, enables, at least in part, mobile devices 100 to communicate with each other via a wireless network 502. For example, as shown, data 504 may be exchanged between various mobile devices 100. Data 504 that is sent from one mobile device 100 to another mobile device 100 may be transmitted according to a particular messaging or communication medium, protocol, or other mechanism. For example, as shown in FIG. 5, data 504 may be sent over the wireless network 502 via a component of a network infrastructure 506. The network infrastructure 506 can include various systems that may be used by the mobile devices 100 to exchange data 504. For example, a peer-to-peer (P2P) system, a short message service centre (SMSC), an email system (e.g. web-based, enterprise based, or otherwise), a web system (e.g. hosting a website or web service), a host system (e.g. enterprise server), and social networking system may be provided by or within or be otherwise supported or facilitated by the network infrastructure 506. The mobile devices 100 may therefore send data to or receive data from other mobile devices 100 via one or more particular systems with which the mobile devices 100 are communicable via the wireless network 502 and network infrastructure 506.

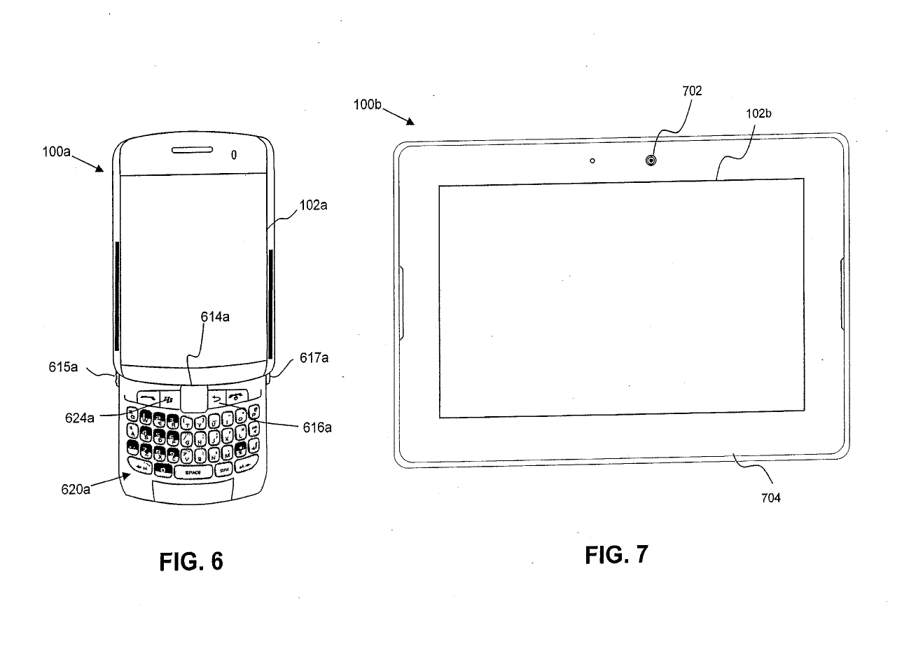

Referring to FIGS. 6 and 7, one example embodiment of a mobile device 100a is shown in FIG. 6 and another example embodiment of a mobile device 100b is shown in FIG. 7. It will be appreciated that the numeral “100” will hereinafter refer to any mobile device 100, including the example embodiments 100a and 100b, those example embodiments enumerated above or otherwise. It will also be appreciated that a similar numbering convention may be used for other general features common between all figures such as a touch-screen display 102.

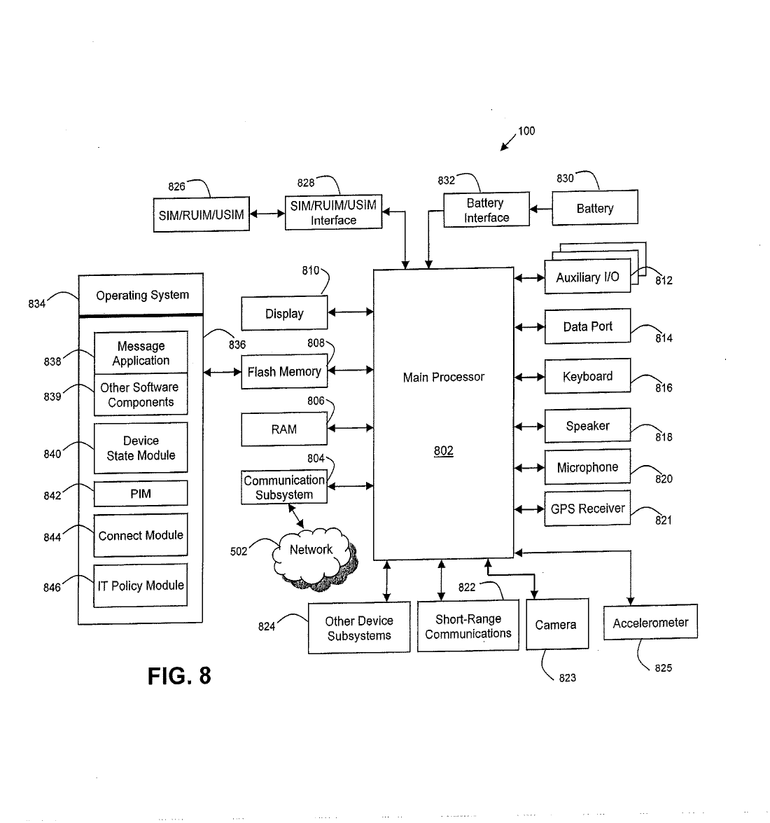

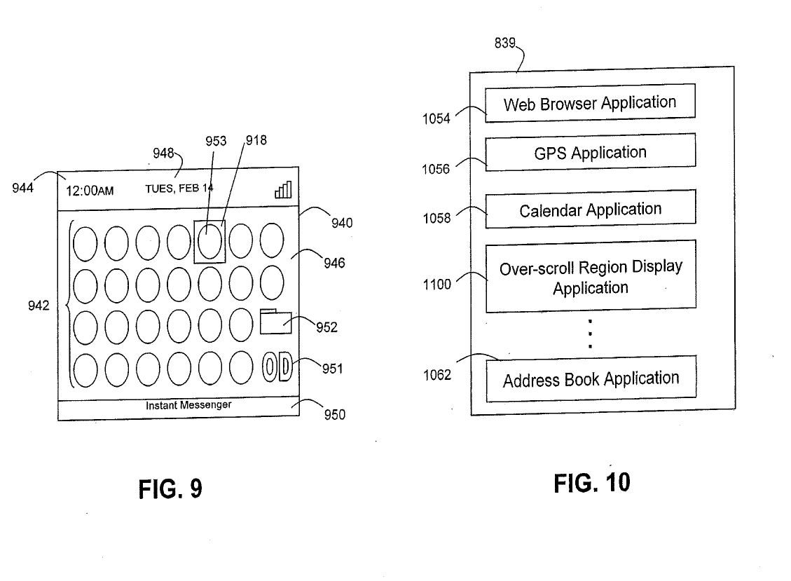

The mobile device 100a shown in FIG. 6 includes a touch-screen display 102a and a cursor or positioning device, which in this example is in the form of a trackpad 614a. Trackpad 614a permits multi-directional positioning of the selection cursor 918 (see FIG. 9) such that the selection cursor 918 can be moved in an upward direction, in a downward direction and, if desired and/or permitted, in any diagonal direction. The trackpad 614a in this example embodiment is situated on the front face of a housing for mobile device 100a as shown in FIG. 6 to enable a user to manoeuvre the trackpad 614a while holding the mobile device 100a in one hand. The trackpad 614a may serve as another input member (in addition to a directional or positioning member) to provide selection inputs to the processor 802 (see FIG. 8) and can preferably be pressed in a direction towards the housing of the mobile device 100b to provide such a selection input. It will be appreciated that the trackpad 614a is only one example embodiment of a suitable positioning device. For example, a trackball, touch-screen display, optical track pad, or other input mechanism may equally apply.

The touch-screen display 102a may display a selection cursor 918 (see FIG. 9) that depicts generally where the next input or selection will be received. The selection cursor 918 may include a box, alteration of an icon or any combination of features that enable the user to identify the currently chosen icon or item. The mobile device 100a in FIG. 6 also includes a programmable convenience button 615a to activate a selection application such as, for example, a calendar or calculator. Further, mobile device 100a also includes an escape or cancel button 616a, a camera button 617a, a menu or option button 624a and a keyboard 620a. The camera button 617a is able to activate photo and video capturing functions, e.g. when pressed in a direction towards the housing. The menu or option button 624a can be used to load a menu or list of options on the display 102a when pressed. In this example embodiment, the escape or cancel button 616a, the menu option button 624a, and a keyboard 620a are disposed on the front face of the mobile device housing, while the convenience button 615a and camera button 617a are disposed at the side of the housing. This button placement enables a user to operate these buttons while holding the mobile device 100a in one hand. The keyboard 620a is, in this example embodiment, a standard QWERTY keyboard, however, it will be appreciated that reduced QWERTY or virtual keyboards (e.g. as provided by a touch-screen display) may equally apply

The example mobile device 100b shown in FIG. 7 includes a touch-screen display 102b, a front camera 702, and a touch-sensitive frame 704. The touch-screen display 102b serves as the position device to provide an input mechanism in addition to display capabilities. The touch-sensitive frame also provides another input mechanism, for example, to control menu options of the mobile device 100b.

It will be appreciated that for the mobile device 100, a wide range of one or more positioning or cursor/view positioning mechanisms such as a touch/track pad, a positioning wheel, a joystick button, a mouse, a touch-screen, a set of arrow keys, a tablet, an accelerometer (of For sensing orientation and/or movements of the mobile device 100 etc.), OLED, or other whether presently known or unknown may be employed. Similarly, any variation of keyboard 620 may be used. It will also be appreciated that the mobile devices 100 shown in FIGS. 6 and 7 are for illustrative purposes only and various other mobile devices 100 are equally applicable to the following example embodiments. Other buttons may also be disposed on the mobile device housing such as colour coded “Answer” and “Ignore” buttons to be used in telephonic communications.

To aid the reader in understanding the structure of the mobile device 100, reference will now be made to FIGS. 8 through 10.

Referring first to FIG. 8, shown therein is a block diagram of an example embodiment of a mobile device 100. The mobile device 100 includes a number of components such as a main processor 802 that controls the overall operation of the mobile device 100. Main processor 802 is directly or indirectly connected to the components of the mobile device 100, as shown in FIG. 8. Communication functions, including data and voice communications, are performed through a communication subsystem 804. The communication subsystem 804 receives messages from and sends messages to a wireless network 502. In this example embodiment of the mobile device 100, the communication subsystem 804 is configured in accordance with the Global System for Mobile Communication (GSM) and General Packet Radio Services (GPRS) standards, which is used worldwide. Other communication configurations that are equally applicable are the 3G and 4G networks such as EDGE, UMTS and HSDPA, LTE, Wi-Max etc. New standards are still being defined, but it is believed that they will have similarities to the network behaviour described herein, and it will also be understood by persons skilled in the art that the example embodiments described herein are intended to use any other suitable standards that are developed in the future. The wireless link connecting the communication subsystem 804 with the wireless network 502 represents one or more different Radio Frequency (RF) channels, operating according to defined protocols specified for GSM/GPRS communications.

The main processor 802 is also communicatively connected to and interacts with additional subsystems such as a Random Access Memory (RAM) 806, a flash memory 808, a touch-screen display 810, an auxiliary input/output (I/O) subsystem 812, a data port 814, a keyboard 816, a speaker 818, a microphone 820, a GPS receiver 821, short-range communications 822, a camera 823, a accelerometer 825 and other device subsystems 824. Some of the subsystems of the mobile device 100 perform communication-related functions, whereas other subsystems may provide “resident” or on-device functions. By way of example, the display 810 and the keyboard 816 may be used for both communication-related functions, such as entering a text message for transmission over the network 502, and device-resident functions such as a calculator or task list.

The mobile device 100 can send and receive communication signals over the wireless network 502 after required network registration or activation procedures have been completed. Network access is associated with a subscriber or user of the mobile device 100. To identify a subscriber, the mobile device 100 may use a subscriber module component or “smart card” 826, such as a Subscriber Identity Module (SIM), a Removable User Identity Module (RUIM) and a Universal Subscriber Identity Module (USIM). In the example embodiment shown, a SIM/RUIM/USIM 826 is to be inserted into a SIM/RUIM/USIM interface 828 in order to communicate with a network. Without the component 826, the mobile device 100 is not fully operational for communication with the wireless network 502. Once the SIM/RUIM/USIM 826 is inserted into the SIM/RUIM/USIM interface 828, it is connected to the main processor 802.

The mobile device 100 is typically a battery-powered device and includes a battery interface 832 for receiving one or more rechargeable batteries 830. In at least some example embodiments, the battery 830 can be a smart battery with an embedded microprocessor. The battery interface 832 is coupled to a regulator (not shown), which assists the battery 830 in providing power to the mobile device 100. Although current technology makes use of a battery, future technologies such as micro fuel cells may provide the power to the mobile device 100.

The mobile device 100 also includes an operating system 834 and software applications and components 836 to 846 which are described in more detail below. The operating system 834 and the software applications and components 836 to 846 that are executed by the main processor 802 are typically stored in a persistent store such as the flash memory 808, which may alternatively be a read-only memory (ROM) or similar storage element (not shown). Those skilled in the art will appreciate that portions of the operating system 834 and the software applications and components 836 to 846, such as specific device applications, or parts thereof, may be temporarily loaded into a volatile store such as the RAM 806. Other software components can also be included, as is well known to those skilled in the art.

The subset of software applications 836 that control basic device operations, including data and voice communication applications, may be installed on the mobile device 100 during its manufacture. Software applications may include a message application 838, a device state module 840, a Personal Information Manager (PIM) 842, a connect module 844 and an IT policy module 846. A message application 838 can be any suitable software program that allows a user of the mobile device 100 to send and receive electronic messages, wherein messages are typically stored in the flash memory 808 of the mobile device 100. A device state module 840 provides persistence, i.e. the device state module 840 ensures that important device data is stored in persistent memory, such as the flash memory 808, so that the data is not lost when the mobile device 100 is turned off or loses power. A PIM 842 includes functionality for organizing and managing data items of interest to the user, such as, but not limited to, e-mail, contacts, calendar events, and voice mails, and may interact with the wireless network 502. A connect module 844 implements the communication protocols that are required for the mobile device 100 to communicate with the wireless infrastructure and any host system, such as an enterprise system, that the mobile device 100 is authorized to interface with. An IT policy module 846 receives IT policy data that encodes the IT policy, and may be responsible for organizing and securing rules such as the “Set Maximum Password Attempts” IT policy.

Other types of software applications or components 839 can also be installed on the mobile device 100. These software applications 839 can be pre-installed applications (i.e. other than message application 838) or third party applications, which are added after the manufacture of the mobile device 100. Examples of third party applications include games, calculators, utilities, etc.

The additional applications 839 can be loaded onto the mobile device 100 through at least one of the wireless network 502, the auxiliary I/O subsystem 812, the data port 814, the short-range communications subsystem 822, or any other suitable device subsystem 824.

The data port 814 can be any suitable port that enables data communication between the mobile device 100 and another computing device. The data port 814 can be a serial or a parallel port. In some instances, the data port 814 can be a USB port that includes data lines for data transfer and a supply line that can provide a charging current to charge the battery 830 of the mobile device 100.

For voice communications, received signals are output to the speaker 818, and signals for transmission are generated by the microphone 820. Although voice or audio signal output is accomplished primarily through the speaker 818, the display 810 can also be used to provide additional information such as the identity of a calling party, duration of a voice call, or other voice call related information.

Referring now to FIG. 9 the mobile device 100 may display a main screen 940, which can be set as the active screen when the mobile device 100 is powered up. The main screen 940 in this example embodiment generally includes a status region 944 and a theme background 946, which provides a graphical background for the display 102. The theme background 946 displays a series of icons 942 in a predefined arrangement on a graphical background. In some themes, the main screen 940 may limit the number icons 942 shown on the main screen 940 so as to not detract from the theme background 946, particularly where the background 946 is chosen for aesthetic reasons. The theme background 946 shown in FIG. 9 provides a grid of icons. It will be appreciated that typically several themes are available for the user to select and that any applicable arrangement may be used. An example icon shown in FIG. 9 is an “OD” icon 951 used to indicate an overscroll region display application 1100, as will be described below. One or more of the series of icons 942 is typically a folder 952 that itself is capable of organizing any number of applications therewithin, as well as or instead of images, videos, data files, etc.

The status region 944 in this example embodiment includes information about mobile device 100, including a date/time 948 and wireless signal strength. The theme background 946, in addition to a graphical background and the series of icons 942, also includes a status bar 950. The status bar 950 provides information to the user based on the location of the selection cursor 918, e.g. by displaying a name for the icon 953 that is currently highlighted.

An application, such as message application 838 may be initiated (opened or viewed) from display 102 by highlighting a corresponding icon 953 using the positioning device 614a and providing a suitable user input to the mobile device 100. For example, message application 838 may be initiated by moving the positioning device 614a such that the icon 953 is highlighted by the selection box 918 as shown in FIG. 9, and providing a selection input, e.g. by pressing the trackpad 614a.

FIG. 10 shows an example of other software applications and components 839 that may be stored and used on the mobile device 100. Only examples are shown in FIG. 10 and such examples are not to be considered exhaustive. In this example, a web browser application 1054 may be used to access the internet by the user. There is also an address book 1062 that manages and displays contact information. A GPS application 1056 may be used to determine the location of a mobile device 100. A calendar application 1058 that may be used to organize appointments. Another example application is an overscroll region display application 1100. As will be discussed below, the overscroll region display application 1100 may be operable to display information or features associated with the mobile or an application of the mobile device in the overscroll region 118, 118a, 118b, or 120.

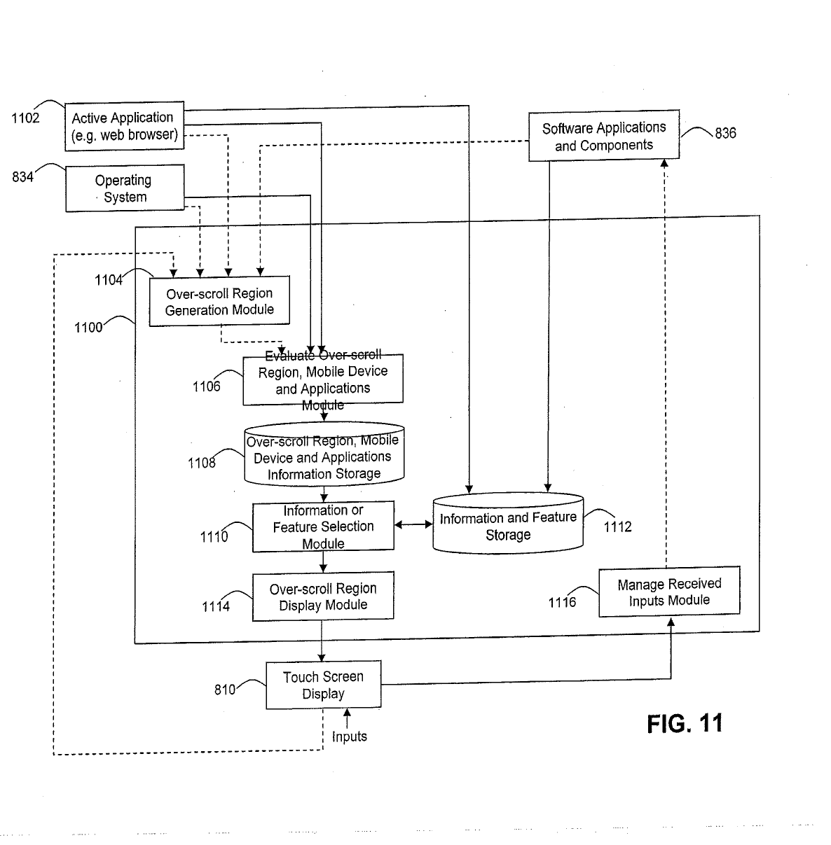

Referring to FIG. 11, an example configuration of the overscroll region display application 1100 is provided. The overscroll region display application 1100 can request details of activity occurring in, or receive inputs from, a component that generates an overscroll region 118, 118a, 118b, or 120 to be displayed, such as the active application 1102 that is open and displayed in displayed portion 106 (e.g. web browser 1054), operating system 834, or other software applications and components 836 of the mobile device, in order to determine what information and/or features to display in the overscroll region.

In some example embodiments, an overscroll region 118, 118a, 118b, or 120 is generated by the active application 1102 or operating system 834 and then sent to the overscroll region display application 1100. In an example embodiment, the operating system 834 can generate overscroll regions across all applications, including the active application 1102, to implement overscroll regions system-wide across the mobile device 100 without the need for an active application 1102 to support the feature of displaying the overscroll region.

In another example embodiment, the overscroll region display application 1100 can generate an overscroll region 118, 118a, 118b, or 120. For example, the overscroll region display application 1100 can include an overscroll region generation module 1104, which is communicable with the operating system 834 to determine graphical user interface information, the active application 1102 to determine the content 104 and its boundaries, and the touch-screen display 810 to determine the scrolling input 300 and display information. Using this information, overscroll region generation module 1104 can generate an overscroll region 118, 118a, 118b, or 120 using known methods such as those carried out by the active application 1102 or operating system 834 to generate the overscroll region.

The overscroll region display application 1100 in the example of FIG. 11 includes an evaluate overscroll region, mobile device and applications module 1106 for determining information associated with an overscroll region 118, 118a, 118b, or 120, the mobile device and applications on the mobile device. Module 1106 is communicable with a component that generates the overscroll region, such as the operating system 834, or active application 1102. Application 1100 also includes an overscroll region, mobile device and applications information storage 1108 for storing and retrieving information associated with the overscroll region, the mobile device and applications on the mobile device. Application 1100 also includes an information or feature selection module 1110 to determine information or features associated with the mobile or an application of the mobile device, to be displayed in the overscroll region. Application 1100 also includes an information and feature storage 1112 for storing and retrieving the information or features associated with the mobile or an application of the mobile device, an overscroll region display module 1114 for instructing the display 810 to display the overscroll region with at least one information or feature, and a manage received inputs module 116 for transmitting information about inputs received at the display, to the appropriate software application or component for processing.

The information and feature storage 1112 obtains the information or features associated with the mobile device or an application of the mobile device from active application 1102 and other software applications 836 of the mobile device. Example of the information or features include: current time, current date, wireless signal strength, wireless carrier information, icons or symbols indicating Wi-Fi service, battery strength, an unread email, an unheard voicemail, access to a main screen, access to information, and icons or symbols indicating features of a particular application of the mobile device (e.g. icons related to a messaging application and a media player application and features within those applications).

The evaluate overscroll region, mobile device and applications module 1106 receives or otherwise obtains an overscroll region 118, 118a, 118b, or 120 and determines various information associated with the overscroll region, such as its dimensions, shape, duration and corresponding scrolling input 300. It will be appreciated that module 1106 can obtain and evaluate the same overscroll region repeatedly as it is being displayed, in order to reflect changes in the overscroll region, due to a changing scrolling input 200, 208, 300. 308, 400 or 408, for example. The information associated with the overscroll region is stored in the overscroll region, mobile device and applications information storage 1108.

The information or feature selection module 1110 retrieves information associated with an overscroll region 118, 118a, 118b, or 120 and selects information or features associated with the mobile device or an application of the mobile device, from the information and feature storage 1112, and based on the information associated with the overscroll region. The information or feature selection module 1110 sends the selected information and/or features to the overscroll region display module 1114.

The overscroll region display module 1114 obtains information or features associated with the mobile device or an application of the mobile device, from the information or feature selection module 1110, and send instructions to the display 810 for displaying the overscroll region 118, 118a, 118b, or 120 with at least one information or feature associated with the mobile device or an application of the mobile device.

The display 810 can receive inputs entered by the user and transmit information about these inputs to the manage received inputs module 1116. For example, when the overscroll region 118, 118a, 118b, or 120 displays icons (e.g. a create a message icon, a forward a message icon, a reply to a message icon, and filing a message icon) related to a particular application (e.g. an email application), the display may detect and receive a user selection of one of the icons. The display can then transmit information about the icon selection to the manage received inputs module.

The manage received inputs module 1116, receives the information, determines the appropriate software application or component to process this information, and forwards the information to that software application or component, for processing. For example, after receiving information that the display received a selection of a create a message icon, the managed received inputs module then determines that the email application is appropriate to process this information, and transmits this information to the email application. The email application can then invoke the functionality of creating a new message.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 100 or accessible or connectable thereto. Any application or module herein described may be implemented using computer readable/executable instructions or operations that may be stored or otherwise held by such computer readable media.

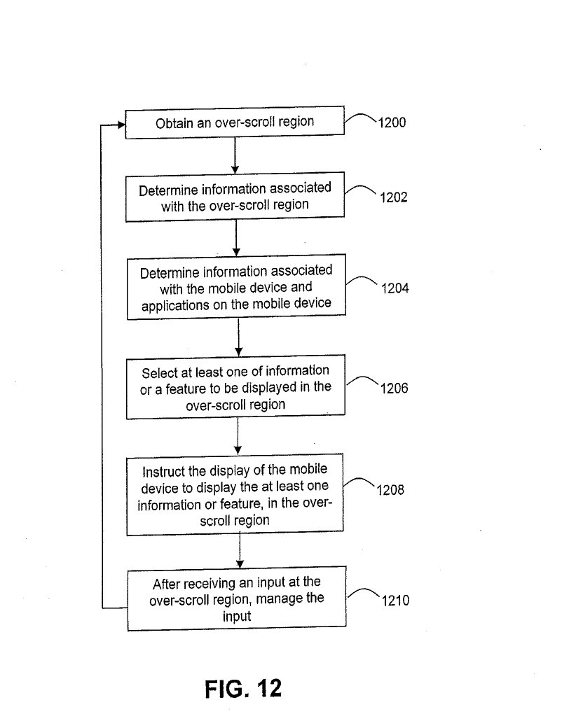

Referring to FIG. 12, an example set of processor or computer executable instructions is provided for displaying an overscroll region 118, 118a, 118b, or 120 on a mobile device 100.

At block 1200, an overscroll region 118, 118a, 118b, or 120 to be displayed on a mobile device 100 is obtained. The overscroll region is obtained after the mobile device receives a scrolling input, such as for example scrolling input 200, 208, 300, 300′, 300″, 308, 400, 408 (as discussed herein in relation to FIGS. 2a-2b, 3a-3b, 4a-4b, 13, 14, 15 and 16) or other example scrolling input. For example, the overscroll region can be generated from a component responsible for the graphical user interface of the mobile device 100 such as the operating system 834 (of FIGS. 8 and 11), active application 1102 (of FIG. 11) currently displayed in displayed portion 106, or other software applications and components 836 of mobile device 100 that can generate an overscroll region. In another example embodiment, the overscroll region display application 1100 can generate an overscroll region using the overscroll region generation module 1104 (of FIG. 11).

At block 1202, information associated with the overscroll region 118, 118a, 118b, or 120 can be determined. Block 1202 may be implemented by the evaluate overscroll region, mobile device and applications module 1106 (of FIG. 11). The information associated with the overscroll region can include for example its dimensions, shape, duration and corresponding scrolling input 300.

At block 1204, information associated with the mobile device and applications on the mobile device can be determined. Block 1204 may be implemented by the evaluate overscroll region, mobile device and applications module 1106 (of FIG. 11). In an example embodiment, information that can be determined includes: information associated with the active application and its features displayed in displayed portion 106, information associated with features of the active application which are not displayed in displayed portion 106, information associated with the mobile device, and information associated applications not displayed in displayed portion 106. For example, the evaluate overscroll region, mobile device and applications module 1106 (of FIG. 11) can analyze and determine the data and features associated with active application displayed in displayed portion 106. The determined data and features can be later used at block 1206, to select at least one of information or a feature of the mobile device or at least one application of the mobile device, that is associated with the determined data and features. It will be appreciated that the determined data and features associated with active application can include other information contained in the active application (and sometimes not explicitly displayed in the active application), such as images, website links and metadata, for example.

At block 1206, at least one of information or a feature (associated with the mobile device or at least one application of the mobile device), is selected, to be displayed in the in the overscroll region 118, 118a, 118b, or 120. This selection can be based on at least one of the following: the information associated with the overscroll region (as determined as block 1202); and data and features associated with the active application currently displayed in displayed portion 106) (as determined at block 1204). Block 1206 may be implemented by the information or feature selection module 1110 (of FIG. 11). The dimensions and shape of the overscroll region determined at block 1202 can be used to determine the amount of information and/or features to display in the overscroll region, in an example embodiment. For example, the dimensions and shape determined at block 1202 can be used to determine if there is room to display primary information and/or features 118a, or both primary and secondary information and/or features 118a (of FIGS. 4a-4c), in the overscroll region. Furthermore, the active application (currently displayed in displayed portion 106), other software applications (not currently displayed in displayed portion 106), and information about the mobile device itself, can provide information and/or features to display in the overscroll region, in example embodiments. Examples of the at least one of information or a feature (associated with the mobile device or at least one application of the mobile device), that are selected are discussed herein (for example in the discussions related to FIGS. 1, 2a-2b, 3a-3b and 4a-4c).

At block 1208, the display 810 (of FIGS. 8 and 11) is instructed to display the overscroll region 118, 118a, 118b, or 120 with the selected at least one information or a feature (associated with the mobile device or at least one application of the mobile device). In an example configuration, block 1208 may be implemented by the overscroll region display module 1114 (of FIG. 11).

At block 1210, the display 810 receives an input entered by the user and the input is managed as follows. Based on information about the received input, the appropriate software application or component to process the information is determined. The information about the input is then transmitted to that software application or component, for processing. After the software application or component processes the information (e.g. by invoking appropriate application functionality associated with the input), control returns to block 1200. In an example configuration, block 1210 may be implemented by the managed received inputs module 1116 (of FIG. 11).

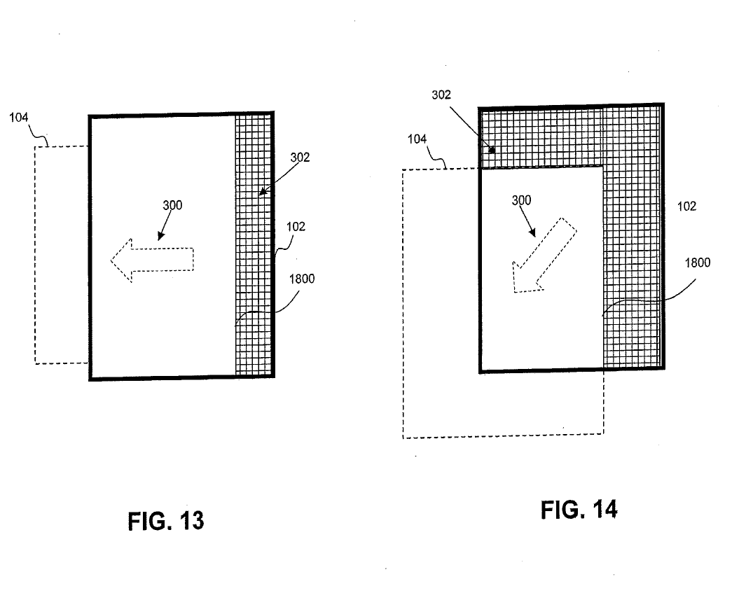

Referring to FIGS. 13 to 14, examples of scrolling inputs 300 that can cause a mobile device 100 to scroll the content 104 past one of its boundaries 1800 are provided. It will be appreciated that the scrolling input 300 can have an arbitrary direction. For example, the scrolling input 300 can provide displacement of content 104 in the vertical direction, horizontal direction (of FIG. 13) and diagonal direction (of FIG. 14), to display an overscroll region 302.

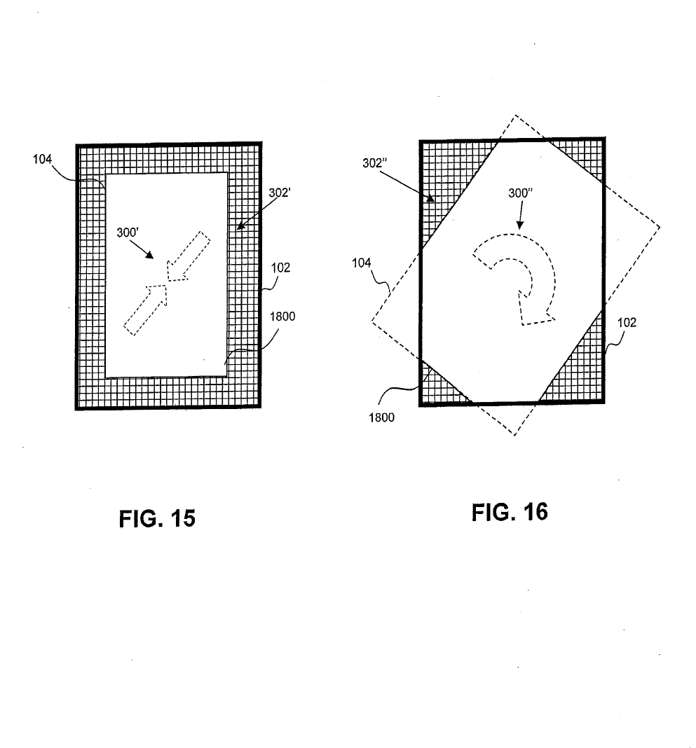

It will be appreciated that other transformations of content 104 can cause one or more of its boundaries 1800 to be displayed within the display 102 of the mobile device 100. The principles expressed herein with respect to overscroll region 302 are suitable to other transformations such as zooming out (i.e. scaling) of content 104 beyond one or more of its boundaries 1800 (of FIG. 15) and rotating content 104 (of FIG. 16). For the sake of clarity, it will be understood that reference to an “overscroll region” also includes reference to over-scaled regions 302′ and over-rotated regions 302″ and that a “scrolling input” includes scaling input 300′ and rotating input 300″, in some example embodiments. For example a rotating input 300″ can include a rotating motion applied to a touch-screen display or changing the physical orientation of the mobile device 100 between portrait and landscape.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific example embodiments, various modifications thereof will be apparent to those skilled in the art as outlined in the appended claims.

1. A method of displaying information or a feature on a electronic device having a display, the method comprising:
obtaining an overscroll region at the display; and
displaying in the overscroll region, at least one of information or a feature associated with the electronic device or at least one application of the electronic device.

2. The method of claim 1, further comprising receiving a scrolling input to cause the display of the at least one of the information or the feature.

3. The method of claim 1, further comprising receiving a gesture to cause the display of the at least one of the information or the feature.

4. The method of claim 1, further comprising determining information associated with the overscroll region.

5. The method of claim 4, wherein the information associated with the overscroll region comprises at least one dimension of the overscroll region.

6. The method of claim 1, further comprising selecting the at least one of information or a feature associated with the electronic device or at least one application of the electronic device.

7. The method of claim 6, wherein the selecting of the at least one of information or a feature associated with the electronic device or at least one application of the electronic device, is based on an application displayed on the display.

8. The method of claim 6, wherein the selecting of the at least one of information or a feature associated with the electronic device or at least one application of the electronic device, is based on a feature of an application displayed on the display.

9. The method of claim 1, wherein the at least one of information or a feature associated with the electronic device or at least one application of the electronic device, comprises at least one of current time, current date, wireless signal strength, wireless carrier information, Wi-Fi service, and battery strength.

10. The method of claim 1, wherein the at least one of information or a feature associated with the electronic device or at least one application of the electronic device, is displayed in a text format or an icon format.

11. The method of claim 1, further comprising receiving an input to cause the display of the at least one of the information or the feature to be maintained.

12. The method of claim 1, further comprising receiving a second gesture to cause the display of the at least one of the information or the feature to be maintained.

13. The method of claim 1, wherein when the overscroll region is displayed, at least part of an application that was displayed on the display is no longer displayed.

14. An electronic device to display information or a feature of the electronic device, comprising:
a display; and
a processor, connected to the display, and configured to:
obtain an overscroll region at the display; and
display at least one of information or a feature associated with the electronic device or at least one application of the electronic device, in the overscroll region.

15. The electronic device of claim 14, wherein the processor is further configured to receive a scrolling input.

16. The electronic device of claim 14, wherein the processor is further configured to receive a gesture.

17. The electronic device of claim 14, wherein the processor is further configured to determine information associated with the overscroll region.

18. The electronic device of claim 17, wherein the information associated with the overscroll region comprises at least one dimension of the overscroll region.

19. The electronic device of claim 14, wherein the processor is further configured to select the at least one of information or a feature associated with the electronic device or at least one application of the electronic device.

20. The electronic device of claim 14, wherein the processor is further configured to select the at least one of information or a feature associated with the electronic device or at least one application of the electronic device, based on an application displayed on the display.

21. The electronic device of claim 14, wherein the processor is further configured to select the at least one of information or a feature associated with the electronic device or at least one application of the electronic device, based on a feature of an application displayed on the display.

22. The electronic device of claim 14, wherein the at least one of information or a feature associated with the electronic device or at least one application of the electronic device, comprises at least one of current time, current date, wireless signal strength, wireless carrier information, Wi-Fi service, and battery strength.

23. The electronic device of claim 14, wherein the at least one of information or a feature associated with the electronic device or at least one application of the electronic device, is displayed in a text format or an icon format.

24. The electronic device of claim 14, wherein the display is a touch-screen display.

25. The electronic device of claim 14, wherein the processor is further configured to receive an input to cause the display of the at least one of the information or the feature to be maintained.

26. The electronic device of claim 14, wherein the processor is further configured to receive a second gesture to cause the display of the at least one of the information or the feature to be maintained.

27. The electronic device of claim 14, wherein when the overscroll region is displayed, at least part of an application that was displayed on the display is no longer displayed.

28. A computer readable storage medium comprising computer executable instructions to display information or a feature of the electronic device having a display, comprising:
obtaining an overscroll region at the display; and
displaying at least one of information or a feature associated with the electronic device or at least one application of the electronic device, in the overscroll region.
